(19) United States
(12) Patent Application Publication
(10) Pub. No.: US 2023/0278076 A1
(43) Pub. Date: Sep. 7, 2023

(54) WASHING AN ELEMENT IN A CHROMATOGRAPHY SYSTEM

(71) Applicant: DIONEX SOFTRON GMBH, Gemering (DE)

(72) Inventors: Runsheng Zheng, Munich (DE); Benjamin Eggart, Munich (DE); Anne Morgenstern, Gilching (DE); Martin Samonig, Riegersdorf (DE)

(21) Appl. No.: 18/173,972

(22) Filed: Feb. 24, 2023

(30) Foreign Application Priority Data
Mar. 4, 2022 (DE) 20 2022 101211.3

(51) Int. Cl. B08B 3/04

(52) U.S. Cl. CPC B08B 3/04; G01N 2030/121

(57) ABSTRACT

A method of washing an element in a chromatography system, wherein the method includes performing an element rinse step. The element rinse step includes providing a first washing liquid with a first composition towards the element, and providing a second washing liquid with a second composition towards the element, wherein the second composition is different from the first composition.

### CROSS-REFERENCE TO RELATED APPLICATIONS

This application claims the priority benefit under 35 U.S.C. § 119 to German Patent Application No. 20 2022 101211.3, filed on Mar. 4, 2022, which application is hereby incorporated herein by references in its entirety.

### FIELD

The present invention relates to washing an element in a chromatography system. For example, the element to be washed may be a trap column, but the present invention also pertains to other elements.

### BACKGROUND

Trap column carryover is a challenge to get confident results in each injection, e.g., in the field of proteomics. The root cause is 1) sample type; 2) sample overloading; 3) insufficient column washing; 4) unspecific sample binding; 5) column chemistry, etc. To effectively reduce and/or remove the column carryover, users typically run blank (which significantly sacrifices the sample throughput) or manually program the washing procedure based on knowledge of the LC fluidic setup (which is difficult and time-consuming). That is, to reduce column carryover, users may presently use one of the following. A first option is to run a blank following the sample, which significantly sacrifices the sample throughput and increases the effort/sample. Another option is to program the washing procedure manually for each particular method. It is difficult and time-consuming because it requires users to embrace their knowledge of the LC fluidic setup.

Furthermore, it is also known to use disposable single use trap columns. Such disposable trap columns are known as Evotip and are marketed by Evosep ApS, 5000 Odense C, Denmark. The trap columns are solid phase extraction (SPE) trap columns and are discarded for each injection. However, such a solution is related to a high effort and is environmentally unfriendly.

It is an object of the present invention to overcome or at least alleviate the shortcomings and disadvantages of the prior art. In particular, it is an object of the present invention to provide an improved washing method for elements in a chromatography system.

These objects are met by the present invention.

### SUMMARY

The present invention relates to a method of washing an element in a chromatography system, wherein the method comprises performing an element rinse step, wherein the element rinse step comprises: providing a first washing liquid with a first composition towards the element, and providing a second washing liquid with a second composition towards the element, wherein the second composition is different from the first composition.

That is, the present invention relates to a washing procedure of an element, e.g., a trap column. The washing procedure includes an element rinse step, where different washing liquids, e.g., different plugs of separated washing liquids, are provided to the element.

Providing such a washing procedure with different washing liquids may be superior to providing a washing procedure employing only a single washing liquid.

For example, the present invention may allow a fully automatic, optimized, and easy-to-use solution to remove trap column carryover while maintaining sample throughput and data confidence.

The first composition may comprise at least 70%, preferably at least 80%, further preferably at least 90% of a first solvent, and further preferably may the first composition consist of the first solvent, and the second composition may comprise at most 30%, preferably at most 20%, further preferably at most 10% of the first solvent, and further preferably may the second composition be free of the first solvent.

It should be understood that % in this document generally refers to volume %.

The method may further comprise performing a washing liquid pick up routine, wherein the washing liquid pick up routine comprises at least one washing liquid pick up cycle, wherein each washing liquid pick up cycle comprises: picking up the first washing liquid into a liquid storage section of the chromatography system and picking up the second washing liquid into a liquid storage section of the chromatography system.

Thus, the washing liquids may be picked up separately and stored separately, i.e., as defined liquid plugs. They may thus also be provided to the element to be washed, e.g., the trap column, as such liquids plugs, which may yield superior results.

The system may comprise a pick up needle and a wash port, wherein the pick up needle is located in the wash port throughout the washing liquid pick up routine.

However, it should be understood that it is also possible that the needle picks up at least one of the washing liquids from a vial.

The first washing liquid and the second washing liquid may be provided towards the element as defined liquid plugs.

The element rinse step may comprise providing a third washing liquid with a third composition towards the element, wherein the third composition is different from the first composition and from the second composition.

The washing liquid pick up routine may comprise a plurality of washing liquid pick up cycles, two, three, four, or more than 10 washing liquid pick up cycles, performed one after another.

Performing such a plurality of cycles, and thus providing a plurality of liquid plugs to and through the element for washing may provide good washing results.

The method may comprise receiving a user input relating to the number of washing liquid pick up cycles to be performed and performing the washing liquid pick up cycles.

The method may comprise receiving a user input relating to a pick up volume of the first washing liquid and/or a pick up volume of the second washing liquid, and in the step of picking up the first washing liquid and/or in the step of picking up the second washing liquid, the first and/or second washing liquid may be picked up according to the user input.

The element may comprise a trap column.

The trap column may not be fluidly connected to a separation column throughout performing the element rinse step.

Each washing liquid pick up cycle may comprise picking up the third washing liquid into a liquid storage section of the chromatography system.

In some embodiments, the element may comprise a separation column.

Throughout the element rinse step, a flow rate towards the element may be kept within a range of 10% of a maximum flow rate in the element rinse step, preferably within in a range of 5% of the maximum flow rate in the element rinse step, further preferably within a range of 2% of the maximum flow rate in the element rinse step.

A pressure in the element may be in the range of 50 bar to 1,000 bar during the element rinse step.

The element rinse step may have a duration in the range of 1 s to 4,000 s, preferably 10 s to 1,000 s, further preferably 30 s to 100 s.

In the element rinse step, a total volume in the range of 0.1 μl to 300 μl, preferably 1 μl to 100 μl may be provided through the element.

The first composition and the second composition each may comprise at least one of the following: acetonitrile, methanol, isopropanol, water, tetrahydrofuran, and dimethyl sulfoxide.

The step of picking up the first washing liquid may have a first step duration in the range of 0.1 s to 50 s, preferably 0.2 s to 10 s, further preferably 0.5 s to 4 s.

The step of picking up the second washing liquid may have a second step duration in the range of 0.1 s to 50 s, preferably 0.2 s to 10 s, further preferably 0.5 s to 4 s.

In the step of picking up the first washing liquid, a first volume in the range of 0.2 μl to 100 μl, preferably 1 μl to 80 μl may be picked up.

In the step of picking up the second washing liquid, a second volume in the range of 0.2 μl to 100 μl, preferably 1 μl to 80 μl may be picked up.

The chromatography system may comprise a loading pump.

The washing pick up routine may have a pick up duration in the range of 2 s to 60 s, preferably 3 s to 30 s, further preferably 5 s to 25 s.

The method may further comprise a liquid drain step performed directly before the washing liquid pick up routine.

The needle may be located in the wash port in the liquid drain step.

The first washing liquid and the second washing liquid may be picked up by means of the loading pump.

The method may comprise a pressurization step, wherein a pressure of the first washing liquid and the second washing liquid is increased, wherein the first washing liquid and the second washing liquid are in a section of the chromatography system not fluidly connected to the element in the pressurization step, wherein the pressurization step may be performed before the element rinse step.

Thus, uncontrolled pressure spikes at the element, e.g., the trap column, may be prevented, which may increase the service life of the element. Further, by preventing such pressure spikes, less longitudinal mixing of the liquids plugs may occur prior to washing the element with the liquids.

In the pressurization step, the pressure of the first liquid and the second liquid may be increased to a pressure within 100 bar of the pressure of the element.

In the pressurization step, the pressure of the first liquid and the second liquid may be increased by at least 50 bar, preferably by at least 100 bar, such as by at least 200 bar. In some embodiments, the pressure of the first liquid and the second liquid may be increased by more than 1,000 bar, e.g., by up to 1,500 bar.

The pressurization step may be performed within 60 s before starting the element rinsing step, preferably within 30 s before starting the element rinsing step, such as within 15 s before starting the element rinsing step.

The loading pump may provide the first washing liquid and the second washing liquid towards the element.

The pressure of the first washing liquid and the second washing liquid may be increased by means of the loading pump in the pressurization step.

The present invention also relates to a chromatography system, wherein the chromatography system comprises a controller, wherein the controller is programmed to cause the system to carry out the described method.

The system may comprise a wash port.

The system may comprise the element.

The element may comprise a trap column.

The element may comprise a separation column.

The system may comprise a loading pump.

The system may comprise an analytical pump.

The system may comprise a sample loop.

The system may comprise a waste reservoir.

The system may comprise a valve system, wherein the valve system comprises at least one rotary valve, and preferably at least two rotary valves for changeably fluidly connecting components of the system.

The system may comprise comprises a needle.

The system may comprise a liquid storage section.

Typically, the liquid storage section may be formed by the needle, by a tubing portion adjacent to the needle, and—depending on the amount of liquid to be stored—by the sample loop.

The system may comprise a needle seat.

The system may be configured to carry out the method according to any of the preceding method embodiments.

The present invention further relates to a computer program comprising instructions which, when the program is executed by a controller in a chromatography system, cause the controller to cause the system to carry out the described method.

It will be understood that the chromatography system may comprise any of the features discussed above.

The present invention also relates to a use of the described chromatography system or the described computer program in genomics, proteomics, metabolomics, metagenomics, and/or transcriptomics.

That is, embodiments of the present invention are particularly applicable for the Omics research field, especially the Proteomics application employing trap-and-elute workflow. Overall, embodiments of the present invention may reduce carryover (e.g., in trap columns) effectively without scarifying sample throughput, and consequently, increase the confidence of each injection.

In simple words, in embodiments of the present invention, alternating strong and weak wash liquid plugs are picked up, e.g., from the wash port and are delivered as solvent plugs onto the trap column for quick washing and equilibration, e.g., under a defined flow rate and/or pressure limit.

As regards the terms strong and weak washing liquids, it will be understood that a weak washing liquid (or solvent) generally increases the retention of the analytes in the stationary phase, and a strong washing liquid (or solvent) decreases the retention of the analytes in the stationary phase. It will thus also be understood that whether a washing liquid is strong or weak is also relative to the stationary phase. For example, in reversed-phase HPLC, weak may refer to an aqueous buffer, e.g. However, e.g., in hydrophilic interaction liquid chromatography, such an aqueous buffer may be a strong solvent.

As regards user interaction, when setting up a trap-and-elute method, users can activate the respective function under a tab of “Wash and Equilibration Settings” in a method editor and then define the details of the method Then the instrument will execute the washing and equilibration procedures (e.g., of a trap column) automatically after the end of the gradient separation step and no other actions may be needed.

Embodiments of the present invention thus provide an automatic workflow to allow the sampler to pick up alternating wash liquids to reduce trap column carryover effectively.

Embodiments of the present invention thus relate to a fully automatic, optimized, and easy-to-use solution to remove trap column carryover while maintaining the sample throughput and enhancing data confidence. The embodiments are easy to use. For example, users can define the washing cycle number from a drop-down menu on an instrument method editor without knowing the fluidic setup of the liquid chromatography system. Moreover, embodiments are accommodated for a large sample loop to achieve more extensive washing (up to 16 cycles with a 100 μL loop). Embodiments of the present invention are also economical and environmentally friendly.

Tests using cytochrome C indicate that embodiments of the present invention with 2 liquid plugs can reduce at least two times carryover of hydrophobic peptides and ten times for hydrophilic peptides.

In particular, the carryover may be determined as follows: A run with a sample is performed. Subsequently, the washing method is performed. In this regard, it will be understood that it may also be possible that at least a part of the washing method, e.g., of a trap column, may be performed in parallel with at least a part of the sample run. More particularly, the trap column may be disconnected from a separation column, and an analytical pump may continue to pump liquid into and through the separation column to finalize the sample run, while the trap column is already disconnected from the separation column and undergoes the washing method. Subsequent to the washing method, a blank run is performed. Then, the intensities of targets in the blank run are divided by the corresponding targets in the sample run. Thus, for different washing routines, carryover levels can be defined and evaluated.

Generally, it will be understood that a method of liquid chromatography may be comprised of a gradient separation phase and a separation column washing step. The presently described washing method may be used for the trap column, e.g., a washing method for a trap column may be executed at the end of the gradient separation phase. Further, a trap column washing can be executed in parallel with the separation column washing step. However, the presently described washing method may also be used for a separation column wash at the end of gradient separation step.

It will be understood that the level of reduction may depend on, e.g., the sample type, sample amount and trap column type. Overall, this workflow can at minimum reduce carryover two fold compared to a washing procedure employing only one wash liquid.

More particularly, tests with human tryptic peptide sample indicate that this function can reduce ca. 4 folds of carryover calculated by total peptide intensities in a trap column using 2 cycles of Zebra Wash by consuming around 1.8 mL of wash liquids in total, and it will be understood that different solvents may be used, e.g., acetonitrile, methanol, isopropanol, water, and/or dimethyl sulfoxide.

The present invention is also defined by the following numbered embodiments.

Below, method embodiments will be discussed. These embodiments are abbreviated by the letter “M” followed by a number. Whenever reference is herein made to method embodiments, these embodiments are meant.
M1. A method of washing an element in a chromatography system (10), wherein the method comprises
performing an element rinse step, wherein the element rinse step comprises:
   providing a first washing liquid with a first composition towards the element, and
   providing a second washing liquid with a second composition towards the element, wherein the second composition is different from the first composition.
M2. The method according to the preceding embodiment,
wherein the first composition comprises at least 70%, preferably at least 80%, further preferably at least 90% of a first solvent, and further preferably wherein the first composition consists of the first solvent, and
wherein the second composition comprises at most 30%, preferably at most 20%, further preferably at most 10% of the first solvent, and further preferably wherein the second composition is free of the first solvent.

It should be understood that % in this document generally refers to volume %.
M3. The method according to any one of the preceding embodiments, wherein the method further comprises performing
a washing liquid pick up routine, wherein the washing liquid pick up routine comprises at least one washing liquid pick up cycle, wherein each washing liquid pick up cycle comprises
picking up the first washing liquid into a liquid storage section of the chromatography system (10), and
picking up the second washing liquid into a liquid storage section of the chromatography system (10).
M4. The method according to the preceding embodiment, wherein the system (10) comprises a pick up needle (160) and a wash port (900), wherein the pick up needle (160) is located in the wash port (900) throughout the washing liquid pick up routine.

However, it should be understood that it is also possible that the needle picks up at least one of the washing liquids from a vial.
M5. The method according to any one of the preceding embodiments, wherein the first washing liquid and the second washing liquid are provided towards the element as defined liquid plugs.
M6. The method according to any one of the preceding embodiments,
wherein the element rinse step comprises
providing a third washing liquid with a third composition towards the element, wherein the third composition is different from the first composition and from the second composition.
M7. The method according to any one of the preceding embodiments with the features of embodiment M3,
wherein the washing liquid pick up routine comprises a plurality of washing liquid pick up cycles, preferably two, three, four, or more than 10 washing liquid pick up cycles, performed one after another.
M8. The method according to the preceding embodiment,
wherein the method comprises receiving a user input relating to the number of washing liquid pick up cycles to be performed and performing the washing liquid pick up cycles.
M9. The method according to any one of the preceding embodiments,
wherein the element comprises a trap column (300).
M10. The method according to the preceding embodiment, wherein the trap column (300) is not fluidly connected to a separation column (400) throughout performing the element rinse step.
M11. The method according to any one of the preceding embodiments with the features of embodiment M3 and M6, wherein each washing liquid pick up cycle comprises
picking up the third washing liquid into a liquid storage section of the chromatography system (10).
M12. The method according to any one of preceding the embodiments, but without the features of embodiment M10, wherein the element comprises a separation column (400).
M13. The method according to any one of the preceding embodiments, wherein throughout the element rinse step, a flow rate towards the element is kept within a range of 10% of a maximum flow rate in the element rinse step, preferably within in a range of 5% of the maximum flow rate in the element rinse step, further preferably within a range of 2% of the maximum flow rate in the element rinse step.
M14. The method according to any one of the preceding embodiments, wherein a pressure in the element is in the range of 50 bar to 1,000 bar during the element rinse step.
M15. The method according to any one of the preceding embodiments, wherein the element rinse step has a duration in the range of 1 s to 4,000 s, preferably 10 s to 1,000 s, further preferably 30 s to 100 s.
M16. The method according to any one of the preceding embodiments, wherein in the element rinse step, a total volume in the range of 0.1 μl to 300 μl, preferably 1 μl to 100 μl is provided through the element.
M17. The method according to any one of the preceding embodiments, wherein the first composition and the second composition each comprise at least one of the following: acetonitrile, methanol, isopropanol, water, tetrahydrofuran, and dimethyl sulfoxide.
M18. The method according to any one of the preceding embodiments with the features of embodiment M3, wherein the step of picking up the first washing liquid has a first step duration in the range of 0.1 s to 50 s, preferably 0.2 s to 10 s, further preferably 0.5 s to 4 s.
M19. The method according to any one of the preceding embodiments with the features of embodiment M3, wherein the step of picking up the second washing liquid has a second step duration in the range of 0.1 s to 50 s, preferably 0.2 s to 10 s, further preferably 0.5 s to 4 s.
M20. The method according to any of the preceding embodiments with the features of embodiment M3, wherein in the step of picking up the first washing liquid, a first volume in the range of 0.2 μl to 100 μl, preferably 1 μl to 80 μl is picked up.
M21. The method according to any one of the preceding embodiments with the features of embodiment M3, wherein in the step of picking up the second washing liquid, a second volume in the range of 0.2 μl to 100 μl, preferably 1 μl to 80 μl is picked up.
M22. The method according to any one of the preceding embodiments with the features of embodiment M3, wherein the method comprises receiving a user input relating to a pick up volume of the first washing liquid and/or a pick up volume of the second washing liquid, and wherein in the step of picking up the first washing liquid and/or in the step of picking up the second washing liquid, the first and/or second washing liquid are picked up according to the user input.
M23. The method according to any one of the preceding embodiments, wherein the chromatography system (10) comprises a loading pump (200).
M24. The method according to any one of the preceding embodiments and with the features of embodiment M3, wherein the washing pick up routine has a pick up duration in the range of 2 s to 60 s, preferably 3 s to 30 s, further preferably 5 s to 25 s.
M25. The method according to any one of the preceding embodiments with the features of embodiments M3, wherein the method further comprises a liquid drain step performed directly before the washing liquid pick up routine.
M26. The method according to the preceding embodiment and with the features of embodiment M4, wherein the needle (160) is located in the wash port (900) in the liquid drain step.
M27. The method according to any one of the preceding embodiments with the features of embodiment M3 and M23, wherein the first washing liquid and the second washing liquid are picked up by means of the loading pump (200).
M28. The method according to any one of the preceding embodiments,
wherein the method comprises a pressurization step, wherein a pressure of the first washing liquid and the second washing liquid is increased, wherein the first washing liquid and the second washing liquid are in a section of the chromatography system not fluidly connected to the element in the pressurization step,
wherein the pressurization step is performed before the element rinse step.
M29. The method according to the preceding embodiment, wherein in the pressurization step, the pressure of the first liquid and the second liquid is increased to a pressure within 100 bar of the pressure of the element.
M30. The method according to any one of the 2 preceding embodiments, wherein in the pressurization step, the pressure of the first liquid and the second liquid is increased by at least 50 bar, preferably by at least 100 bar, such as by at least 200 bar.
M31. The method according to any one of the 3 preceding embodiments, wherein the pressurization step is performed within 60 s before starting the element rinsing step, preferably within 30 s before starting the element rinsing step, such as within 15 s before starting the element rinsing step
M32. The method according to any one of the preceding embodiments and with the features of embodiment M23, wherein the loading pump provides the first washing liquid and the second washing liquid towards the element.
M33. The method according to any one of the preceding embodiments and with the features of embodiments M23 and M28, wherein the pressure of the first washing liquid and the second washing liquid is increased by means of the loading pump.

Below, system embodiments will be discussed. These embodiments are abbreviated by the letter “S” followed by a number. Whenever reference is herein made to system embodiments, these embodiments are meant.
S1. A chromatography system (10), wherein the chromatography system (10) comprises a controller (820), wherein the controller (820) is programmed to cause the system (10) to carry out the method of any one of the preceding method embodiments.
S2. The system (10) according to any one of the preceding system embodiments, wherein the system (10) comprises a wash port (900).
S3. The system (10) according to any one of the preceding system embodiments, wherein the system (10) comprises the element.
S4. The system (10) according to the preceding embodiment, wherein the element comprises a trap column (300).
S5. The system (10) according to any one of the 2 preceding embodiments, wherein the element comprises a separation column (400).
S6. The system (10) according to any one of the preceding system embodiments, wherein the system (10) comprises a loading pump (200).
S7. The system (10) according to any one of the preceding system embodiments, wherein the system (10) comprises an analytical pump (500).
S8. The system (10) according to any one of the preceding system embodiments, wherein the system (10) comprises a sample loop (100).
S9. The system (10) according to any one of the preceding system embodiments, wherein the system (10) comprises a waste reservoir (700).
S10. The system (10) according to any one of the preceding system embodiments, wherein the system comprises a valve system, wherein the valve system comprises at least one rotary valve (620, 640), and preferably at least two rotary valves (620, 640) for changeably fluidly connecting components of the system (10).
S11. The system (10) according to any one of the preceding system embodiments, wherein the system comprises a needle (160).
S12. The system (10) according to any of one the preceding system embodiments, wherein the system (10) comprises a liquid storage section.

Typically, the liquid storage section may be formed by the needle, by a tubing portion adjacent to the needle, and—depending on the amount of liquid to be stored—by the sample loop.
S13. The system (10) according to any one of the preceding system embodiments, wherein the system (10) comprises a needle seat (140).
S14. The system (10) according to any one of the preceding system embodiments, wherein the system (10) is configured to carry out the method according to any of the preceding method embodiments.
C1. A computer program comprising instructions which, when the program is executed by a controller (820) in a chromatography system (10), cause the controller (820) to cause the system (10) to carry out the method of any one of the preceding method embodiments.

It will be understood that the chromatography system may comprise any of the features discussed above.
U1. Use of the chromatography system (10) according to any one of the preceding system embodiments or the computer program according to the preceding embodiment in genomics, proteomics, metabolomics, metagenomics, and/or transcriptomics.

### DESCRIPTION OF FIGURES

Embodiments of the present invention will now be described with reference to the accompanying drawings, and it should be understood that the drawings should only illustrate, but not limit, the present invention.

FIG. 1 depicts an exemplary chromatography system in a configuration where a sample is transferred to a trap column;

FIG. 2 depicts the exemplary chromatography system in a pre-compression configuration;

FIG. 3 depicts the exemplary chromatography system in a sample analyze configuration;

FIG. 4 depicts the exemplary chromatography system in a sample loop decompression configuration;

FIG. 5 depicts the exemplary chromatography system in a drain solvent configuration;

FIG. 6 depicts a section of the exemplary chromatography system in a first washing solvent pick up configuration;

FIG. 7 depicts the section of the exemplary chromatography system in a second washing solvent pick up configuration;

FIG. 8 depicts the section of the exemplary chromatography system in a first washing solvent pick up configuration;

FIG. 9 depicts the section of the exemplary chromatography system in a second washing solvent pick up configuration;

FIG. 10 depicts the exemplary chromatography system in a configuration directly prior to washing with the first and second washing solvent;

FIGS. 11 to 13 depict the exemplary chromatography system in trap column washing configurations; and

FIG. 14 graphs corresponding to operation parameters of the exemplary chromatography.

### DETAILED DESCRIPTION

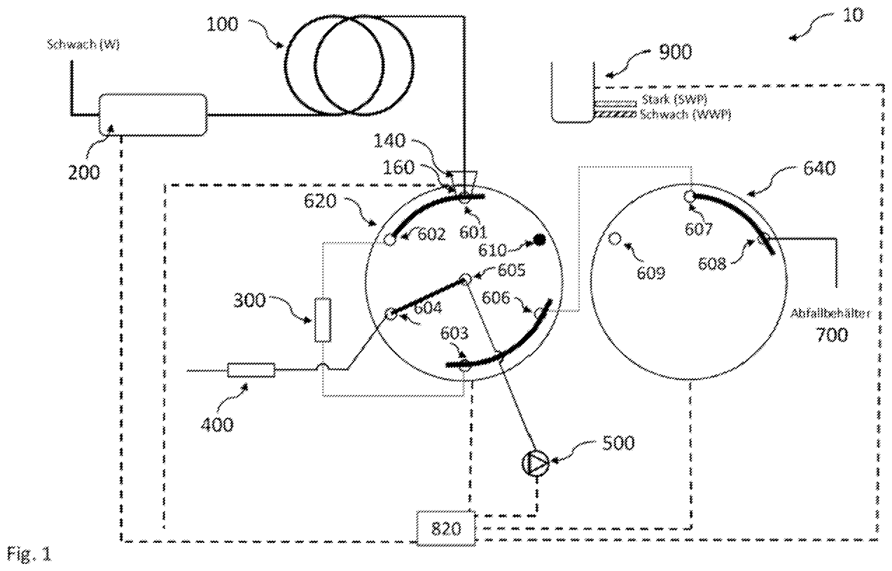

FIG. 1 depicts a chromatography system 10, which may also be referred to as system 10 for sake of simplicity. The system 10 comprises a loading pump 200 being realized as a metering device that may comprise a housing and a piston and two ports, and the system 10 further comprises a trap column 300, and also a wash port 900.

The chromatography system 10 may further comprise: a sample loop 100, a sample pick up means seat 140, a sample pick up means 160, which is shown as a sample pick up needle, an analytical pump 500, a separation column 400, a waste reservoir 700, a first distributor valve 620 comprising a plurality of ports and a plurality of connecting elements configured to changeably connect to the plurality of ports of the first distributor valve 620, wherein the plurality of ports of the first distributor valve 620 comprises a first port 601 directly fluidly connected to the seat 140, a second port 602 and a third port 603 that are both directly fluidly connected to the trap column 300, a fourth port 604 directly fluidly connected to the separation column 400, a fifth port 605 directly fluidly connected to the analytical pump 500, and a sixth port 606 directly fluidly connected to a second distributor valve 640. The second distributor valve 640 may comprise a plurality of ports and a plurality of connecting elements configured to changeably connect to the plurality of ports of the second distributor valve 640, wherein the plurality of ports of the second distributor valve 640 comprises a seventh port 607 directly fluidly connected to the first distributor valve 620, and an eighth port 608 directly fluidly connected to the waste 700. The second distributor valve 640 may also comprise a ninth port 609. However, the exact connection of the ninth port 609 may not be important for the present description. Furthermore, the first valve 620 may also comprise a further additional port 610, which may be sealed, and which may therefore also be referred to as a dead end 610 or blind port 610.

When an element is said to be directly fluidly connected to a port A of a distribution valve 620, 640 in the specification or in the claims, this denotes a connection between the respective port A and the element without there being another port of the same distribution valve being disposed between the port A and the respective element. For example, the trap column 300 is directly fluidly connected to ports 602 and 603 of distribution valve 620. It will be understood that, e.g., in FIG. 1, trap column 300 is also fluidly connected to the port 606. However, this fluid connection between the trap column 300 and the port 606 is via port 603, and is therefore not a direct fluid connection.

The chromatography system 10 additionally comprises a control unit 820 that may control operation of the system 10. For ease of illustration, this control unit 820 is only depicted in FIG. 1. However, it should be understood that this is for ease of illustration only and that the control unit 820 is in fact present in all of the configurations depicted in FIGS. 1 to 13.

Each of the valves 620, 640 may be referred to as a distribution valve. Each valve may comprise a stator and a rotor, and a rotatable drive. The stator may comprise a plurality of ports, and the rotor may comprise connecting elements to connect the ports to one another. The rotor can be rotated with respect to the stator (by means of the rotatable drive) so that the connecting elements may establish connections between different ports. The rotatable drive can include a motor, gearbox and encoder.

In one embodiment, the pump 200 may be a metering device. The metering device may further comprise a housing and a piston. The metering device may also comprise a stepper motor or a drive device for moving the piston in the housing.

The control unit 820 may also be referred to as controller 820, and the control unit 820 can be operatively connected to other components, as depicted by dashed lines in FIG. 1. More particularly, the controller 820 may be operatively connected to the distribution valves 620, 640 (and more particularly to the rotatable drives thereof), to the sample pick up means 160, to the analytical pump 500, to the pump 200 (more particularly, to the stepper motor of the sampling device 200), and to the wash port 900 (and more particularly to fluid supplies of the wash port 900).

The controller 820 can include a data processing unit and may be configured to control the system and carry out particular method steps. The controller can send and/or receive electronic signals for instructions. The controller can also be referred to as a microprocessor. The controller can be contained on an integrated-circuit chip. The controller can include a processor with memory and associated circuits. A microprocessor is a computer processor that incorporates the functions of a central processing unit on a single integrated circuit (IC), or sometimes up to a plurality of integrated circuits, such as 8 integrated circuits. The microprocessor may be a multipurpose, clock driven, register based, digital integrated circuit that accepts binary data as input, processes it according to instructions stored in its memory and provides results (also in binary form) as output. Microprocessors may contain both combinational logic and sequential digital logic. Microprocessors operate on numbers and symbols represented in the binary number system.

Furthermore, it should be understood that in some embodiments, the system may be configured to measure pressure, e.g., by means of the pressure sensor located in the pump 200 or fluidly connected to the pump 200. The pressure sensor may also be operatively connected to the controller 820, and the controller 820 may use readings of these pressure sensors when controlling the operation of the system. The pressure sensors may be configured to measure the pressure directly. However, it should be understood that also other parameters may be measured and may be used to determine the respective pressures (and that such a procedure should also be understood as a pressure measurement and the components involved should be understood as pressure sensors). For example, it will be understood that when the pump 200 supplies a solvent, the power consumption of the pump 200 will also depend on the pressure at which it operates—the higher the operating pressure, the higher the power consumption. Thus, e.g., the power consumption of the pump 800 may also be used to derive the pressure present at the pumps 800 Thus, the system 100 may generally be configured to measure pressures present at different locations of the system 10.

It will be understood that the system 10 depicted in the Figures may be used to supply a sample to the trap column 300 and then from the trap column to the analytical column 300.

Typically, a sample may be picked up by the needle 160, and sucked into sample loop 100. The configuration depicted in FIG. 1 can be used to provide a sample from the sample loop 100 to the trap column 300. More particularly, in this configuration, the sample loop 100 is fluidly connected to the trap column 300 and further to the waste 700, which may also be referred to as the waste reservoir 700. Thus, decreasing the volume of the pump 200 (e.g., by moving the piston inwardly) will lead to a flow of fluid towards the waste 700, such that a sample initially present in the sample loop 100 may be transferred to the trap column 300.

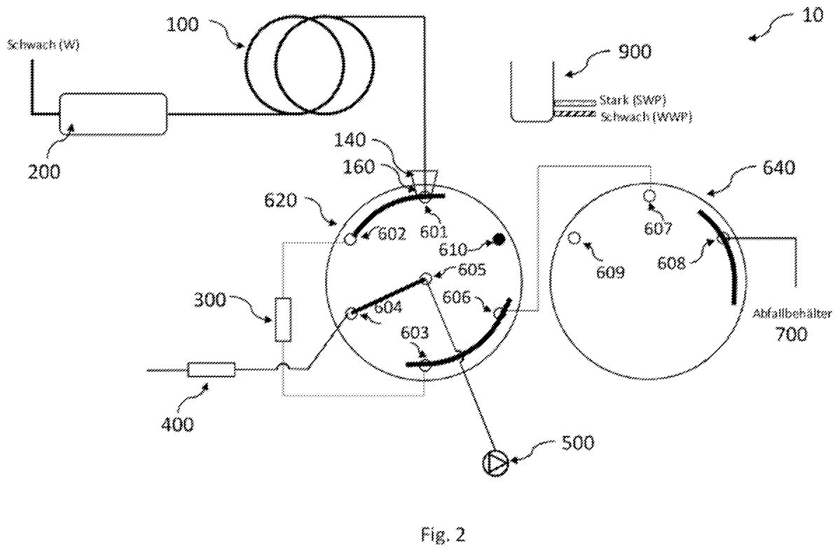

FIG. 2 depicts a precompression configuration of the system 10. While the valve 620 is in the same position as depicted in FIG. 1, the position of valve 640 is different. More particularly, the seventh port 607 is not fluidly connected to ambient (e.g., to the waste 700) in this configuration, and this end therefore constitutes a dead end. Thus, a pressure in a section fluidly connected to the trap column 300 and including the trap column 300 may be set by means of the pump 200. It will be understood that it is generally intended to later connect the trap column 300 to the separation column 400 and to then cause the sample to flow from the trap column 300 to the separation column 400 for sample analysis. This is typically done at elevated pressures, e.g., at a pressure of 1,200 bar, and it is generally advantageous that the trap column 300 is also at an elevated pressure when fluidly connecting the trap column 300 to the separation column 400. Thus, the configuration in FIG. 2 may be in particular be used to bring the trap column 300 to an elevated pressure.

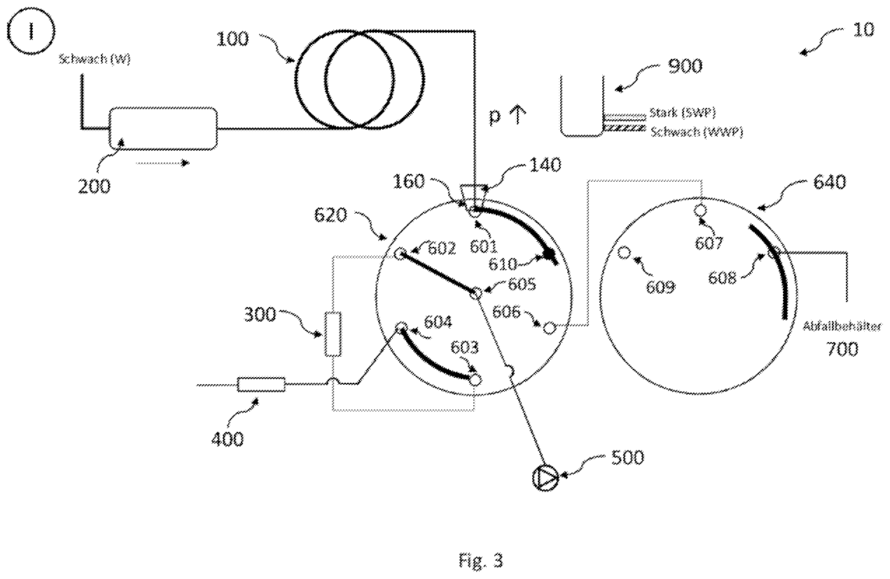

Next, the system may be switched to the configuration depicted in FIG. 3. As depicted, the first valve 620 is in a different position compared to the position depicted in FIG. 2. In this position, the analytical pump 500 is fluidly connected to the trap column 300 and to the separation column 400. Thus, a flow generated by the analytical pump 500 may be used to analyze the sample.

Further, the sample loop 100 is fluidly connected to a dead end, e.g., to the dead end port 610.

In this configuration, the needle 160 is located in the needle seat 140. Furthermore, it will be understood that the sample loop 100 and the components fluidly connected thereto are still in an elevated pressure state, as there was nothing causing the previously present high pressure to dissipate. This is indicated by the letter p in combination with the upwardly pointing arrow. For example, the sample loop 100 may be at a pressure of approximately 1,200 bar, where it will be understood that the exact value depends on the tightness of the components and tolerances.

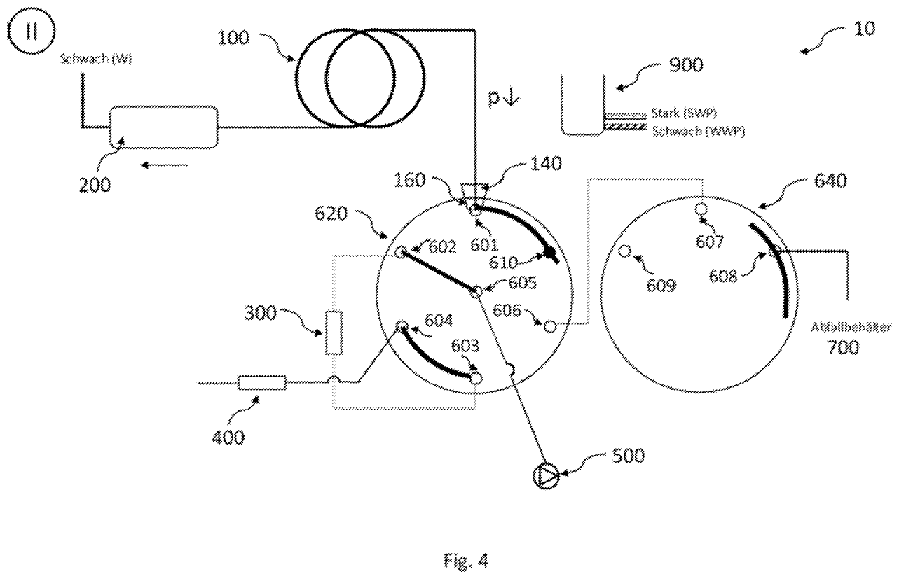

As depicted in FIG. 4, the pressure in the sample loop 100 may be decreased, e.g., to ambient pressure. More particularly, it will be understood that the positions of the valves 620 and 640 correspond to the positions depicted in FIG. 3. Similar to the position of FIG. 2, in the position of FIG. 4, the pump 200 may again be used to control a pressure in the sample loop 100 and in the components fluidly connected thereto. Thus, by increasing the volume in the pump 200 (e.g., by moving a piston outwardly, as indicated by the leftward facing arrow), a pressure in the sample loop 100 may be decreased.

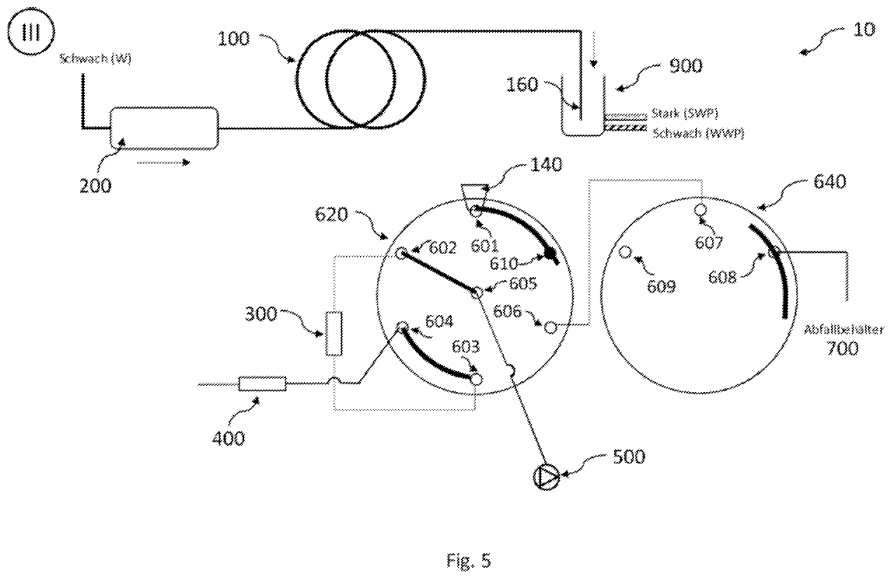

As depicted in FIG. 5, the needle 160 may be moved to the wash port 900 (where it will again be understood that the valves 620, 640 are maintained in the previously described positions).

As depicted throughout the drawings, the pump 200 may also be connected to a reservoir of a weak solvent W. It will thus be understood that the normal “working” solvent used is the weak solvent W. In the configuration depicted in FIG. 5, forward, i.e., inward movement of the piston of the pump 200, which may be a metering device, leads to solvent W being drained into the wash port 900.

As depicted, the wash port 900 may comprise solvent supplies. In the depicted embodiments, the wash port 900 comprises a strong solvent supply supplying a strong washing solvent SWP and a weak solvent supply supplying a weak solvent. Furthermore, it will be understood that the wash port 900 is also configured to drain any solvent present in the wash port and that all this may be controlled by the control unit 820 (cf. FIG. 1).

Thus, in FIG. 5, solvent W may be drained into the wash port 900 and the wash port may remove this solvent W.

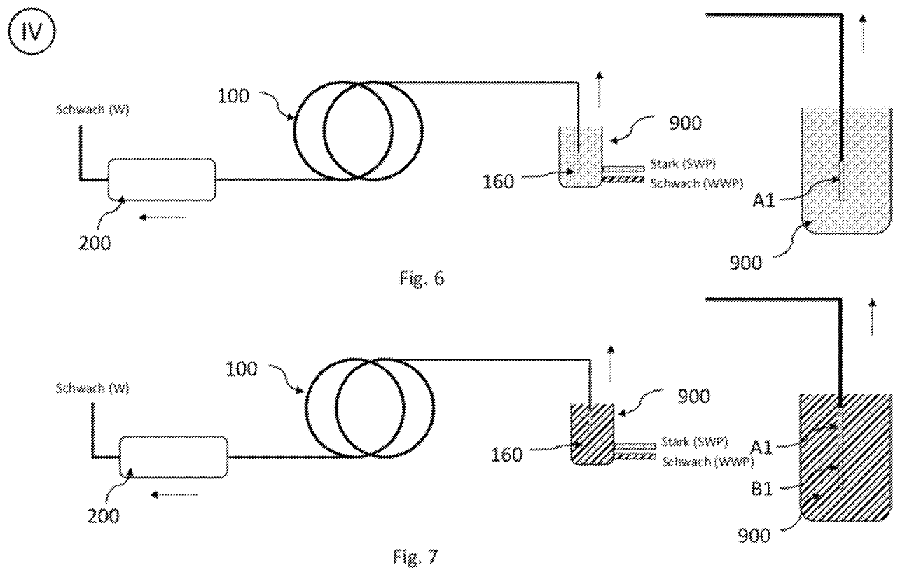

FIGS. 6 to 9 show a section of the system 10 including the sample loop 100, the needle 160 and the wash port 900, and in all of these Figures, there is a panel on the right depicting the wash port 900 and the needle, as well as tubing directly adjacent to the needle in greater detail.

According to FIG. 6, the wash port 900 is flushed with the strong solvent SWP, which may also be referred to as a first washing liquid. The first washing liquid is then sucked into the needle and the adjacent tubing by means of the pump 200. Thus, at the distal portion of the needle and/or tubing, a plug A1 of the first washing liquid is provided.

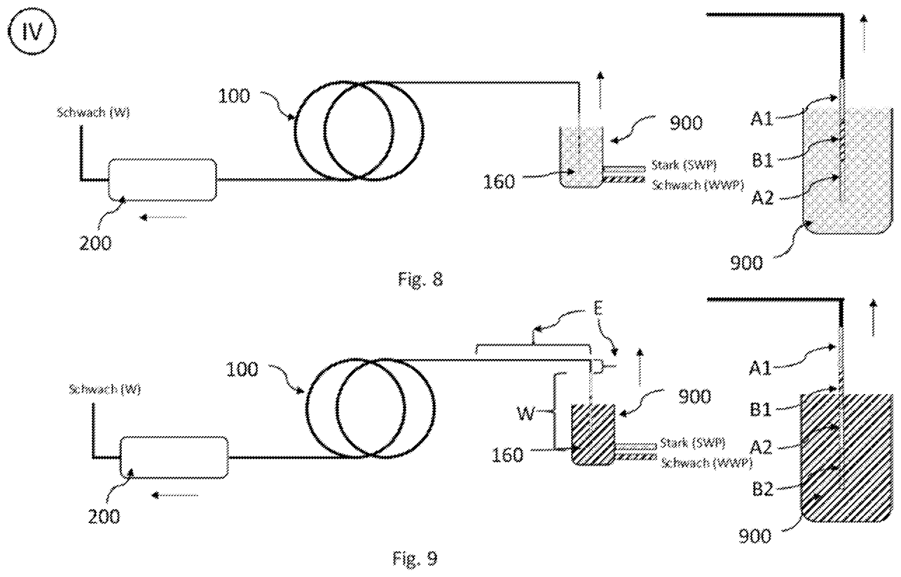

According to FIG. 7, the wash port 900 may then be flushed with the second solvent, which may also be referred to as second washing liquid. Again, it will be understood that the first solvent may in this step (or prior thereto) be removed from the wash port 900. In this configuration, when the wash port 900 is filled with the second solvent, which may also be referred to as a weak solvent WWP, this solvent may be sucked into the needle and adjacent tubing by means of the pump 200. Thus, at the end of this step, there is a plug B1 of the second washing liquid at the most distal portion of the needle and/or tubing, and directly proximal thereto is the discussed plug A1.

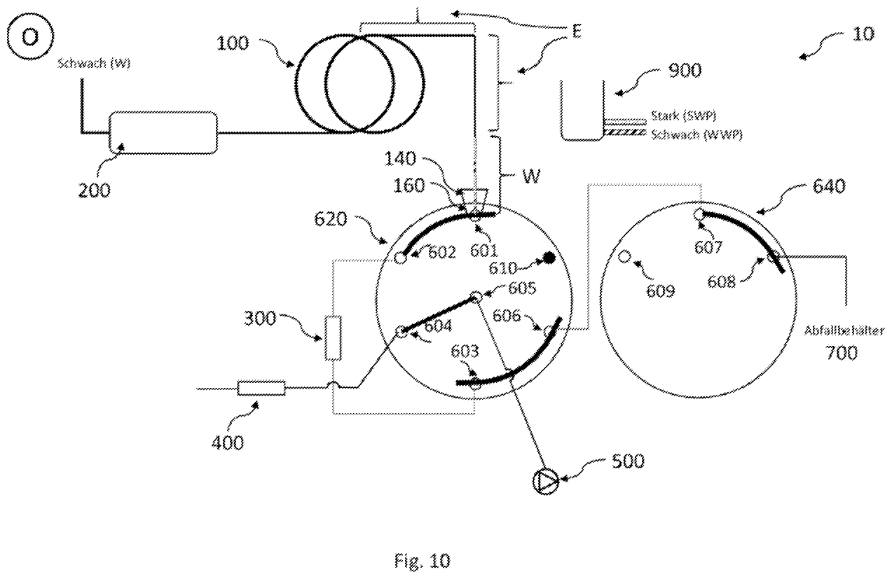

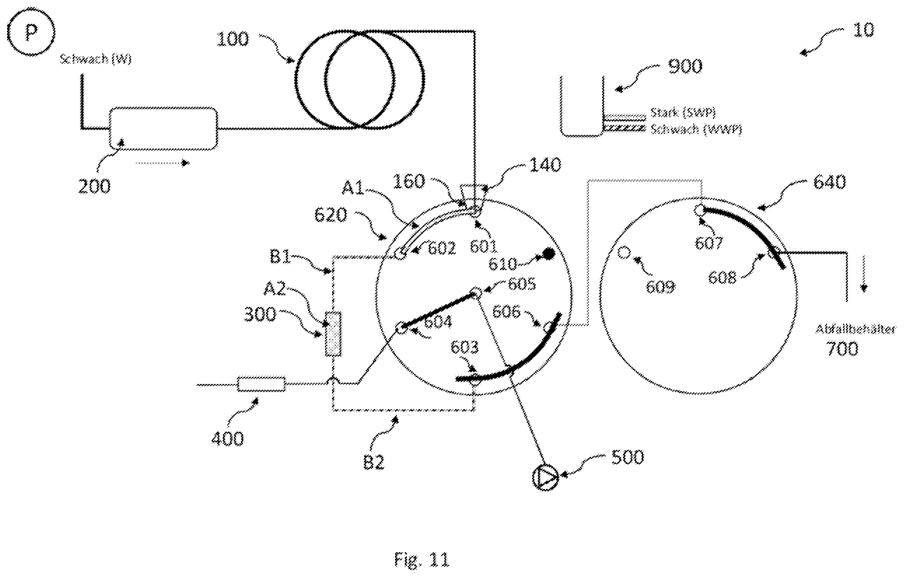

The process described with regard to FIGS. 6 and 7 may also be repeated, as depicted in FIGS. 8 and 9. More particularly, according to FIG. 8, the wash port 8 may again be loaded with the first washing liquid SWP, and a further plug A2 of the first washing liquid may be sucked into the system (see FIG. 8), and the wash port may again be loaded with the second washing liquid WWP, and a further plug B2 of the second washing liquid WWP may be sucked into the system (see FIG. 9).

It will thus be understood that the process described with regard to FIGS. 6 and 7 may be considered as one cycle of solvent plug loading, and that this cycle may be performed different times. As described with reference to FIGS. 6 to 9, the cycle may be repeated twice. However, the skilled person will understand that this is merely exemplary and that the cycle may also be repeated 3, 4, 5, or more times.

More particularly, a user may choose how many cycles of the solvent loading procedure to perform and the controller 820 may control the system 10 accordingly.

The volumes of the plugs A1, B1, . . . , An, Bn, may be set automatically by a driver. For example, each plug may have a volume in the range of 0.2 μl to 10 μl, such as in the range of 2 μl to 3 μl, and the plug volume may depend on the number of cycles and/or a volume of the sample loop 100.

The solvent plugs A1, B1, . . . , An, Bn, together define a wash volume W (see FIG. 9), and proximal thereto, the weak solvent is present, which may define a equilibration volume E.

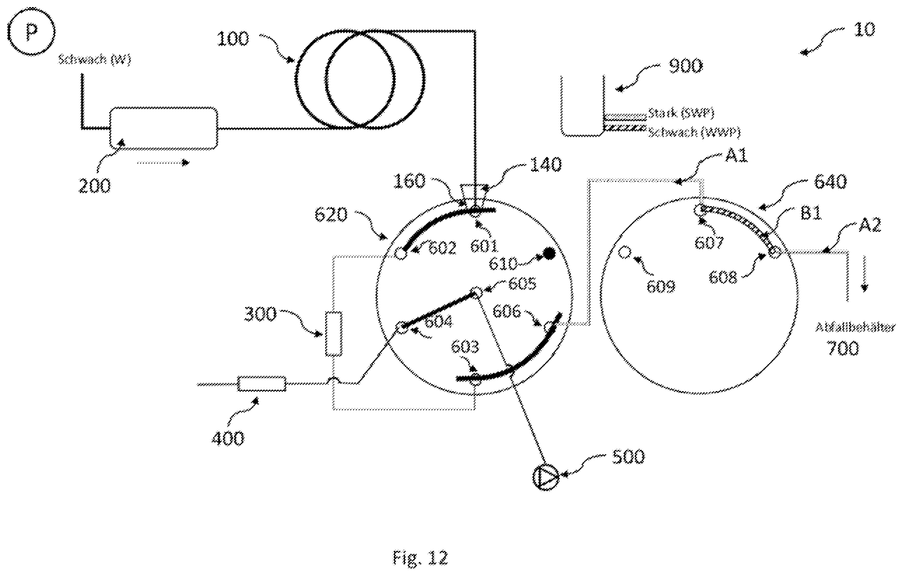

The wash volume W and equilibration volume E may then be used to wash and equilibrate the trap column 300 for the next sample, as depicted in FIGS. 10 to 12.

As more particularly depicted in FIG. 10, the system 10, and more particularly the valves 620 and 640 may be switched so that the pump 200 and the sample loop 100 are fluidly connected to the trap column 300 and to the waste 700.

In this configuration, a flow may be caused by the pump 200, which causes the wash volume W to flow through the trap column 300 and further downstream towards and to the waste 700.

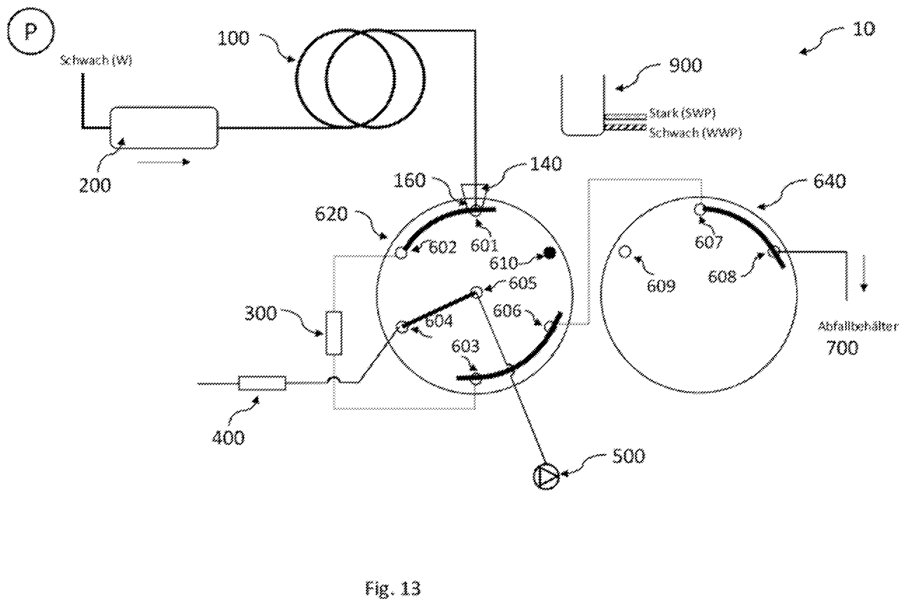

This is depicted in FIG. 11, where the washing liquid plug B2 is located between port 603 and trap column 300, washing liquid plug A2 is located in the trap column 300, washing liquid plug B1 is located between the trap column 300 and the port 602, and washing liquid plug A1 is located between the ports 602 and 601. For ease of reference, the washing liquid plugs may also be referred to as solvent plugs. The skilled person will understand that this Figure is for illustrative purposes only and that it is in fact unlikely that the solvent plugs are located exactly as depicted in FIG. 11, as this would require, e.g., the volumes of the solvent plugs to exactly correspond to the respective components and/or tubings. However, the skilled person will understand that the solvent plugs may travel through the system 10 in the described manner and will at least substantially maintain their order.

FIG. 12 depicts the system 10 at a time which is later that the time of FIG. 11. In this configuration, the solvent plug B2 has already been drained to waste 700, the solvent plug A2 is present between the waste 700 and the port 608, the solvent plug B2 is present between the ports 608 and 607, and the solvent plug A1 is present between the ports 607 and 606.

FIG. 13 further depicts the system 10 at a time which is later that the time of FIG. 12. In this configuration, all of the solvent plugs B2, A2, B1, A1 have been drained into the waste 700, and the equilibration volume has been pushed through the trap column 300 to equilibrate the trap column 300 for an additional sample loading.

Overall, the present technology thus provides a method of washing a component, e.g., a trap column 300 with different solvents provided to the component as solvent plugs.

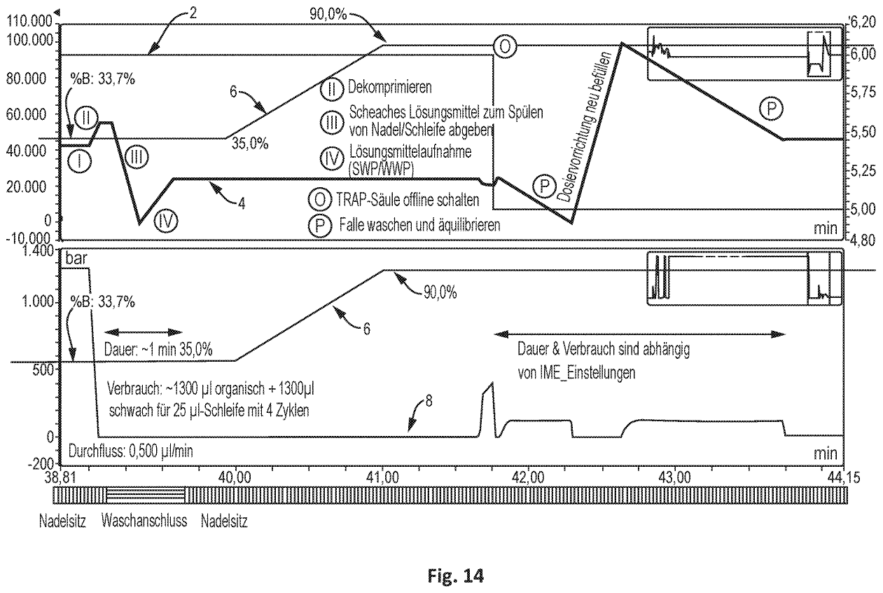

FIG. 14 depicts different graphs or signals 2, 4, 6, 8 as a function of time for an operation of the system 10.

With regard to the system 10, it will be understood that the components, with the exception of the analytical pump 500, the tubing connecting the analytical pump 500 to the first valve 620, the separation column 400, and the tubing connected to the separation column 400, may also be part of a sampler used to pick up a sample and washing fluid.

Signal 2 indicates the position of the first valve 620 in different phases of the procedure. More particularly, a higher value of 6 (see right y-axis in FIG. 14) indicates that the first valve 620 is in the position depicted, e.g., in FIGS. 3 to 5, and a lower value of 5 (see right y-axis in FIG. 14) indicates that the first valve 620 is in the position depicted, e.g., in FIGS. 10 to 13. That is, the higher value of 6 indicates that the port 601 is connected to dead end port 610, and the lower value of 5 indicates that the port 601 is connected to port 602, thereby connecting the needle seat 140 to the trap column 300.

With regard to the Figures, it will be understood that different phases I to IV, 0 and P are indicated in FIG. 14, and the corresponding phases are also indicated in the corresponding FIGS. 3 to 13.

It will thus be appreciated that throughout the steps depicted in FIGS. 3 to 9, the first valve 620 connects the needle seat 140 to a dead end, and in FIGS. 10 to 13, the first valve 620 connects the needle seat 140 to the trap column 300.

Signal 4 depicts a position of the loading pump 200, and this signal 4 may also be referred to as sampler compress position, as the pump 200 may be used to compress or decompress components fluidly connected thereto. The position of the pump 200 indicates a volume of the fluid accommodation volume in nl as shown in the left y-axis of the upper panel of FIG. 14. More particularly, a higher value of signal 4 correspond to a higher fluid accommodation volume of the pump 200 and a lower value of the signal 4 correspond to a lower fluid accommodation volume of the pump 200. It will be appreciated that the fluid accommodation volume may thus assume values between 0 nl and 100,000 nl (=100 μl). That is, e.g., at a time between 39.50 min and 39.75 min, the fluid accommodation volume is 0, i.e., the loading pump 200 is empty, and at a time between 42.25 min and 42.50 min, the loading pump 200 is completely filled, i.e., the fluid accommodation volume is at 100,000 nl.

As depicted in FIG. 14, during phase I (also see FIG. 3), the pump 200 is in an intermediate position (and at a relatively high pressure).

In phase II (also see FIG. 4), the pressure in the pump 200 is reduced by increasing the fluid accommodating volume in the pump 200, e.g., by moving a piston outwardly, thereby increasing signal 4 in FIG. 14.

In phase III (also see FIG. 5), the fluid accommodation volume of the pump 200 is reduced by emptying solvent into the wash port 900, corresponding to the decrease in signal 4 at III.

In a solvent pickup phase IV (also see FIGS. 6 to 9), the fluid accommodation volume of the pump 200 is increased step by step, corresponding to the increase in signal 4 at IV.

At O (see FIG. 10), the trap column 300 previously connected to the analytical pump 500 and separation column 400 is disconnected from these components, which may also be referred to as “switching the trap column 400 offline”. It is then connected to the pump 200, and the fluid accommodation volume in the pump 200 is reduced to thereby cause the washing liquid (comprising different plugs, as discussed) and the equilibration liquid to flow through the trap column 300 (see phase P in FIG. 10 and FIGS. 11 to 13).

As depicted in FIG. 14, there is a decrease of signal 4 shortly before O, i.e., shortly before connecting the trap column 300 to the pump 200. This corresponds to the pump 200 decreasing its accommodation volume to thereby precompress the fluid in the sample loop 100 to a higher pressure, e.g., to a pressure corresponding to a pressure present in the trap column 300. Once the trap column 300 is connected to the pump 200 (see O in FIG. 14), the fluid accommodation volume of the pump 200 may be increased (see increase in signal 4 in FIG. 14 after O), thereby decompressing the pump 200 and the components fluidly connected thereto, wherein these components also include the trap column 300. The decompression step may be performed with the configuration shown in FIG. 2. E.g., after ambient pressure is reached, the system 10 assumes the configuration according to FIG. 10 to start the washing and equilibration step P.

Subsequently, the pump 200, which may be realized as a metering device, may again be filled with solvent (see phase “refill metering device” in FIG. 14, i.e., by increasing the fluid accommodation volume of the pump 200). For example, if in case it is intended to wash and equilibrate the trap column 300 with a total volume of 70 μl, but at O, there is only 20 μl of liquid present in the loading pump 200, the loading pump 200 may first deliver the 20 μl (see first section P in signal 4), then be refilled, and then deliver an additional 50 μl (see second section P in signal 4). For example, the loading pump 200 may be filled with solvent W connected to it.

FIG. 14 also depicts a signal 6 indicating a solvent composition as supplied by the analytical pump 500. More particularly, the analytical pump supplies a solvent mixture of solvents A and B in varying concentrations, where it will be understood that these solvent do no necessarily correspond to the washing liquids. Signal 6 indicates the vol-% of solvent B in this mixture, staring at 33.7% and then rising to 90.0%. As depicted in FIG. 14, this change of solvent composition supplied by the analytical pump 500 is performed prior to phase O, i.e., while the first valve 620 is in the position depicted, e.g., in FIG. 5, i.e., while the trap column 300 is connected to the analytical pump 500 and the separation column 400. Thus, this relates to a gradient analysis procedure. As also depicted in FIG. 14 (see bottom left), the analytical pump may provide a constant flow of, e.g., 0.500 μl/min.

The lower panel of FIG. 14 further depicts a signal 8 indicating a pressure at the sampler, e.g., in the sample loop 100 and/or in the pump 200.

As discussed, prior to switching the trap column 300 in fluid connection with the analytical pump 500 and the separation column 400, a pressure in the trap column 300 may be increased by means of the pump 200, such that the pump 200 and the sample loop 100 may initially be at a high pressure (see FIG. 3). This pressure may then be reduced to atmospheric pressure (see FIG. 4), and the sample loop 100 and the pump 200 may be maintained at substantially the lower pressure during phases III (see FIG. 5) and picking up the alternating solvents (see FIGS. 6 to 9).

Between the time 41.50 min and 41.75 min, there is an increase in the pressure signal 8. This corresponds to the above described precompression of the pump 200 and components fluidly connected thereto prior to O, i.e., prior to it being connected to the trap column 300, to avoid pressure spikes at the trap column 300.

During phase “P”, i.e., while the washing an equilibration liquids are caused to flow through the trap column 300 (see FIGS. 11 to 13), the pressure in the pump 200 and the sample loop 100 is again slightly increased to cause flow, while the pressure is at atmospheric pressure while the loading pump 200 is refilled.

In the lowermost section of FIG. 14, it is also depicted which position the needle 140 assume, i.e., whether it is located in the needle seat 160 or in the wash port 900.

As also indicated in FIG. 14, in an example, the needle 160 may be in the wash port 900 for approximately 1 minute.

Furthermore, as also indicated in FIG. 14, for an exemplary procedure performed with a sample loop 100 with a volume of 25 μl, and with 4 cycles, i.e., a total of 8 washing liquid plugs, approximately 1,300 μl of organic strong solvent, SWP, and approximately 1,300 μl of weak solvent, WWP, may be used, one reason being that for each “semi cycle”, the wash port 900 is completely filled and emptied, such that each semi cycle uses approximately 200 μl of the respective solvent.

As also depicted in FIG. 14, the skilled person will understand that the duration and solvent consumption for the washing and equilibration procedure, and for the loading step, may depend on settings input by a user in an input method editor (IME).

Overall, in embodiments of the present technology, two (or more) solvents may alternatingly be used to wash a component, e.g., a trap column. For example, the different solvents may comprise a strong and weak solvent and these solvents may be supplied to the components to be washed as solvent plugs. For example, when two different solvents are used, a plug of the first solvent followed by a plug of the second solvent constitute a cycle. Overall, embodiments of the present technology thus achieve a washing cycle with different solvent compositions, and it will be understood that the cycle may be repeated multiple times.

While in the above, embodiments of the present technology have been described with reference to washing methods for washing a trap column, it should be understood that this is merely exemplary and that also other components may be used with the described washing principle, e.g., a separation column, or a separation column and a trap column together. Furthermore, the present technology is also not limiting to picking up alternating wash liquids from the wash port, but they may also be picked up from other positions. The skilled person will also understand that more than two alternating wash liquids may be used to wash trap columns and/or separation columns (e.g., three different liquids, or even more). Furthermore, it is also possible that alternating wash liquids are picked up with different compositions to wash the trap column and/or the separation column, and it is also possible to pick up more than two alternating wash liquids with different compositions to wash trap columns and/or separation columns.

Whenever a relative term, such as “about”, “substantially” or “approximately” is used in this specification, such a term should also be construed to also include the exact term. That is, e.g., “substantially straight” should be construed to also include “(exactly) straight”.

Whenever steps were recited in the above or also in the appended claims, it should be noted that the order in which the steps are recited in this text may be accidental. That is, unless otherwise specified or unless clear to the skilled person, the order in which steps are recited may be accidental. That is, when the present document states, e.g., that a method comprises steps (A) and (B), this does not necessarily mean that step (A) precedes step (B), but it is also possible that step (A) is performed (at least partly) simultaneously with step (B) or that step (B) precedes step (A). Furthermore, when a step (X) is said to precede another step (Z), this does not imply that there is no step between steps (X) and (Z). That is, step (X) preceding step (Z) encompasses the situation that step (X) is performed directly before step (Z), but also the situation that (X) is performed before one or more steps (Y1), . . . , followed by step (Z). Corresponding considerations apply when terms like “after” or “before” are used.

While in the above, preferred embodiments have been described with reference to the accompanying drawings, the skilled person will understand that these embodiments were provided for illustrative purpose only and should by no means be construed to limit the scope of the present invention, which is defined by the claims.

1. A method of washing an element in a chromatography system, wherein the method comprises:
performing an element rinse step, wherein the element rinse step comprises:
providing a first washing liquid with a first composition towards the element, and
providing a second washing liquid with a second composition towards the element, wherein the second composition is different from the first composition.

2. The method according to the preceding claim, wherein the method further comprises performing
a washing liquid pick up routine, wherein the washing liquid pick up routine comprises at least one washing liquid pick up cycle, wherein each washing liquid pick up cycle comprises
picking up the first washing liquid into a liquid storage section of the chromatography system, and
picking up the second washing liquid into a liquid storage section of the chromatography system.

3. The method according to claim 2, wherein the system comprises a pick up needle and a wash port, wherein the pick up needle is located in the wash port throughout the washing liquid pick up routine.

4. The method according to claim 2, wherein the washing liquid pick up routine comprises a plurality of washing liquid pick up cycles, preferably two, three, four, or more than 10 washing liquid pick up cycles, performed one after another

5. The method according to claim 1,
Wherein the first composition comprises at least 70%, preferably at least 80%, further preferably at least 90% of a first solvent, and further preferably wherein the first composition consists of the first solvent, and
wherein the second composition comprises at most 30%, preferably at most 20%, further preferably at most 10% of the first solvent, and further preferably wherein the second composition is free of the first solvent.

6. The method according to claim 1, wherein the first washing liquid and the second washing liquid are provided towards the element as defined liquid plugs.

7. The method according to claim 1, wherein the element comprises a trap column, and wherein the trap column is not fluidly connected to a separation column throughout performing the element rinse step.

8. The method according to claim 1, wherein the element comprises a separation column.

9. The method according to claim 1, wherein in the element rinse step, a total volume in the range of 0.1 μl to 300 μl, preferably 1 μl to 100 μl is provided through the element.

10. The method according to claim 1, wherein the method further comprises a liquid drain step performed directly before the washing liquid pick up routine.

11. The method according to claim 2, wherein the chromatography system comprises a loading pump, and wherein the first washing liquid and the second washing liquid are picked up by means of the loading pump.

12. The method according to claim 1, wherein the chromatography system comprises the loading pump, and wherein the loading pump provides the first washing liquid and the second washing liquid towards the element.

13. The method according to claim 1, wherein the method comprises a pressurization step, wherein a pressure of the first washing liquid and the second washing liquid is increased, wherein the first washing liquid and the second washing liquid are in a section of the chromatography system not fluidly connected to the element in the pressurization step,
wherein the pressurization step is performed before the element rinse step.

14. The method according to claim 13,
wherein in the pressurization step, the pressure of the first liquid and the second liquid is increased to a pressure within 100 bar of the pressure of the element, and/or wherein in the pressurization step, the pressure of the first liquid and the second liquid is increased by at least 50 bar, preferably by at least 100 bar, such as by at least 200 bar.

15. The method according to claim 13, wherein the chromatography system comprises the loading pump, and wherein the pressure of the first washing liquid and the second washing liquid is increased by means of the loading pump.

16. A chromatography system (10), wherein the chromatography system (10) comprises a controller (820), wherein the controller (820) is programmed to cause the system (10) to carry out a method of washing an element in the chromatography system (10), wherein the method comprises:
performing an element rinse step, wherein the element rinse step comprises:
providing a first washing liquid with a first composition towards the element, and
providing a second washing liquid with a second composition towards the element, wherein the second composition is different from the first composition.

17. A computer program comprising instructions which, when the program is executed by a controller (820) in a chromatography system (10), cause the controller (820) to cause the system (10) to carry out a method of washing an element in the chromatography system (10), wherein the method comprises:
performing an element rinse step, wherein the element rinse step comprises:
providing a first washing liquid with a first composition towards the element, and
providing a second washing liquid with a second composition towards the element, wherein the second composition is different from the first composition.
